(19) United States
(12) Patent Application Publication
(10) Pub. No.: US 2016/0144327 A1
(43) Pub. Date: May 26, 2016

(54) CAPROLACTAM-BASED FATTY AMIDE AS HYDROGELLING ADDITIVE

(71) Applicant: ARKEMA FRANCE, Colombes (FR)

(72) Inventor: Michael Y. Bernard, Enghien Les Baines (FR)

(21) Appl. No.: 14/899,169

(22) PCT Filed: Jun. 16, 2014
(86) PCT No.: PCT/FR2014/051471

§ 371 Date: Dec. 17, 2015

(30) Foreign Application Priority Data
Jun. 28, 2013 (FR) 1356315

(51) Int. Cl. B01J 13/00; B01F 17/00

(52) U.S. Cl. CPC B01J 13/00; B01F 17/00; B01F 17/0042

(57) ABSTRACT

The present invention relates to a caprolactam-based fatty amide additive useful as a hydrogelator for aqueous compositions.

### CROSS-REFERENCE TO RELATED APPLICATIONS

This application is a national stage application under 35 U.S.C. 371 of PCT/FR2014/051471, filed Jun. 16, 2014, which claims benefit to French patent application FR 13.56315, filed Jun. 28, 2013.

The present invention relates to a fatty amide additive carrying a carboxylic acid ending or in the salt form which is used as hydrogelator for aqueous compositions, in particular for coatings or adhesives or treatment of fibres or textiles or for detergents, stripping agents, depolluting agents or flocculating agents.

Various systems which can gel in water are already known and used in various applications.

FR 2976948 describes a ternary combination of an acid of boron, such as boric acid, with an N-alkylaldonamide, in particular N-dodecyl-D-glucoanamide, and a monovalent salt, such as NaCl, in order to obtain gels in a (saline) aqueous medium for various applications and in particular in detergency.

The known hydrogelators include those based on lysine derivatives, as described by M. Suzuki et al. in Chem. Soc. Rev., 2009, 38, 967-975, where derivatives used as organogelators are also described. A description is given, among these derivatives, of diurea-esters, diamide-esters or amide-urea-esters, starting from lysine.

A review of hydrogelators was carried out by L. A. Estroff et al. in Chemical Reviews, 2004, 104, 3, 1201-1217, with an inventory of the characterization methods and structures which are known. Conventional amphiphilic derivatives having a hydrophilic head and one or two hydrophobic chains, bolaamphiphiles having two hydrophilic heads bonded via a hydrophobic chain, surfactants having a double ionic head separated by a rigid spacer with two flexible end chains, systems derived from sugars, are singled out, inter alia. It is recognized that there is no applicable general rule which makes it possible to discover a satisfactory compromise between hydrophilicity and hydrophobicity of a molecule and consequently there is no general rule either between the ability to form a gel in an aqueous medium and the tendency to prevent the precipitation of fibres.

The disadvantage of these hydrogelators is the fact that they are based on amino acids, which can undergo side reactions and in particular uncontrolled chain elongations, according to the conditions for the preparation of the said gelators, and can thus affect their fine structure and consequently their performance of gelator. Furthermore, none of the documents cited describes or teaches how to obtain amide additives modified by caprolactam and with improved performance which is a subject-matter of the present invention to overcome the disadvantages of the state of the art.

Specifically, the present invention is attempting to develop novel amide additives modified by a caprolactam structure (equivalent to a C₆ amino acid) without having recourse to amino acids condensed with themselves or to acids and amines which react by polycondensation with by-products to be removed. These modified amides make possible the use of a preparation process which is simple and practical to carry out, with the controlled opening of the ring of the caprolactam, in order to avoid side reactions which are difficult to avoid with an equivalent amino acid and without needing stages of separation and/or purification of the final product, which exhibits a satisfactory rheological performance in an aqueous medium, without affecting the performance specific to the aqueous binders which may be used in association with it.

The first subject-matter of the invention is a hydrogelator additive based on fatty amide, which additive is the product of the addition reaction (without by-products, as in polycondensation) of a fatty acid R₁CO₂H with caprolactam and (which product) carries an end carboxyl functional group in the acid form or in the form salified by a neutralizing agent, the said additive consisting of or comprising the mixture of 3 different amide compounds resulting from the said reaction and which are characterized by the number n of caprolactam units incorporated, which number is respectively 1, 2 and 3, with a mean number n of units (mean per molecule) ranging from 0.8 to 3, preferably from 0.9 to 2.75 and more preferably from 0.9 to 2.5. More particularly, the said 3 compounds can be defined according to the following formula (I) and respectively correspond to n=1, n=2 and n=3

R₁—C(═O)—[NH(CH₂)₅C(═O)—]ₙ₋₁—NH(CH₂)₅—CO₂M (I)

with M being —H or a cation in the case of the said salified form, the said cation being related to the said neutralizing agent.

The said fatty acid R₁CO₂H comprises a number of carbon atoms ranging from 10 to 24, which means that R₁ is an alkyl comprising from 9 to 23 carbon atoms which is preferably linear.

Mention may be made, as suitable examples of R₁CO₂H, of fatty monoacids, such as decanoic acid to undecanoic acid, dodecanoic or lauric acid, tridecanoic acid, tetradecanoic (or myristic) acid, pentadecanoic acid, hexadecanoic acid (palmitic acid), heptadecanoic acid, octadecanoic acid (stearic acid) or their isomers and their mixtures.

The fatty acid R₁CO₂H can also comprise, in its structure, an ethylenic unsaturation, as is the case with oleic acid (9-octadecenoic acid).

R₁CO₂H can comprise, in its structure, a hydroxyl functional group, that is to say can be a fatty hydroxy acid, such as 12-hydroxystearic acid, 9-hydroxystearic acid and/or 10-hydroxystearic acid or 14-hydroxyeicosanoic acid, preferably 12-hydroxystearic acid alone or partially replaced with 9-hydroxystearic acid and/or 10-hydroxystearic acid or 14-hydroxyeicosanoic acid. R₁CO₂H can simultaneously comprise an ethylenic unsaturation and an OH functional group, such as, for example, ricinoleic acid (or 12-hydroxy-9-octadecenoic acid) or 14-hydroxyeicosenoic acid. Preferably, the said fatty acid R₁CO₂H does not comprise any hydroxyl (OH) or amine functional group or other functional groups which can react with the caprolactam, in order to avoid any potential side reaction and to better control the final structure and composition of the said amide additive according to the invention.

According to a possible option, the said amide additive is in the salified form (form of carboxylic acid salt) and the said neutralizing agent is selected from organic or inorganic bases. Mention may be made, as examples of organic bases, of primary, secondary or tertiary amines, preferably tertiary amines, in order to form a cation M which is a quaternary ammonium, the counteranion being the carboxylate carried by the amide chain. Mention may be made, as inorganic base, of an alkali metal hydroxide, such as LiOH, NaOH or KOH, or an alkaline earth metal hydroxide, such as Ca(OH)₂, Mg(OH)₂ or Ba(OH)₂.

More particularly, the additive of the invention can be in the form of a micronized powder, preferably have a volume-average size of less than 50 μm, preferably less than 25 μm. This particle size distribution can be determined directly on the dry powder by laser diffraction, such as, for example, on the Mastersizer® S from Malvern. This technique is based on the principle that particles passing through a laser beam diffract the light according to a different angle as a function of their size: particles having small sizes diffract at large angles, whereas particles having larger sizes diffract at small angles.

The said additive of the invention can be used in particular in the gel form in water or as hydrogelator and more preferably at a content by weight of less than 5% and more preferably still at a content not exceeding 1% by weight, this percentage being defined with respect to the weight of the water+additive.

The second subject-matter of the invention is a process for the preparation of the hydrogelator additive according to the invention, which process comprises a stage of an addition reaction between a fatty acid R₁CO₂H and caprolactam with a molar ratio of the said caprolactam with respect to the said fatty acid ranging from 0.8 to 3, preferably from 0.9 to 2.75 and more preferably from 0.9 to 2.5, the said process not comprising any separation or purification stage.

This reaction is a bulk addition reaction in the molten state which can take place at a temperature ranging from 200° C. to 300° C. and under an inert atmosphere or under pressure ranging from a few bar to a pressure of less than 30 bar. A catalyst can be used for this reaction, such as, for example, a Lewis acid. After cooling, the product obtained is micronized by mechanical grinding or by an air jet at a temperature lower than the melting point. A sieving can make it possible to obtain a fine and controlled particle size distribution with a volume-average size of less than 50 μm, preferably less than 25 μm, measured by laser diffraction, such as, for example, on the Mastersizer® S from Malvern.

Another subject-matter of the invention is an aqueous composition which comprises, as hydrogelator, at least one additive as defined above or as obtained by the described process of the invention.

Such an aqueous composition can be an aqueous composition with or without binder. Without binder, this can correspond to a simple dispersion of the said additive in the water which operates as hydrogelator. The hydrogelator effect is displayed by an increase in viscosity with the achievement of a gel, by the fact of the molecular combinations in the fibrous system formed, with the hydrogelation being a compromise between the molecular hydrophobicity/hydrophilicity of the additive, on the one hand, and, on the other hand, between the level of dissolution (limited but sufficient) and a tendency towards precipitation to be avoided. This can also correspond to a solution or dispersion of aqueous dispersant or surfactant for the requirements of detergency or of dispersion of an oily product (oils of vegetable or mineral or hydrocarbon origin) or solid product which is finely divided (dispersion of resins in particulate form).

The said aqueous composition can be a composition of organic binder which can be reactive or non-reactive, single-component or two-component, monomer or oligomer or resin or polymer or mixture of monomers and oligomers or resins or polymers. As it concerns an aqueous medium, the said binders can be water-soluble, water-dispersible via their own structure or dispersible in water using a surfactant or dispersant specific for an aqueous medium.

In particular, the pH of the aqueous composition is basic, preferably of at least 9, more preferably of at least 10. This pH is adjusted by excess addition of a base, that is to say addition beyond the simple neutralization of the said end carboxylic acid functional group of the said additive, and this remains equally valid for the additive in the gel form in water.

According to a first preferred option, the said composition is an aqueous binder composition and preferably an aqueous coating composition, in particular an aqueous varnish, paint or ink composition, or an adhesive composition or a cosmetic composition or a composition for the treatment of fibres or textiles, with the said hydrogelator additive being used as rheology additive.

According to another option, the said aqueous composition is a surfactant composition, in particular a detergent or stripping agent or depolluting agent or flocculating agent composition. As in the aqueous binder compositions, the said amide additive is present as hydrogelator in order to gel the applicative composition for reasons specific to the final use planned for the applicative composition.

Another subject-matter of the invention is the use of an additive as defined above according to the invention as hydrogelator additive in aqueous compositions. Such a use has already been described above, in particular in aqueous binder compositions, more particularly in aqueous coating or adhesive or cosmetic compositions or composition for the treatment of fibres or textiles, in particular as rheology additive. Another use in aqueous compositions concerns surfactant compositions and in particular detergent, stripping agent, depolluting agent or flocculating agent compositions. Finally, the finished products resulting from the use as hydrogelator of the said additive of the invention, in particular selected from: a coating or an adhesive or a cosmetic or a treated fibre or a treated textile or a detergent or a stripping agent or a depolluting agent or a flocculating agent, are also covered by the invention. The hydrogel as product which results from these uses is also covered by the invention.

The examples which follow are presented by way of illustration of the invention and its performance and do not in any way limit this coverage.

### EXPERIMENTAL PART

I—Starting Materials Used

TABLE 1
Starting materials used

| Product | Role | Commercial reference | Supplier |
|---|---|---|---|
| Stearic acid | Reactant | Stearic acid | Aldrich |
| Caprolactam | Reactant | ε-Caprolactam | Aldrich |
| 1.0M Sodium | Acid | Sodium hydroxide solution | Aldrich |
| hydroxide solution | | ~1.0M | |

II—Examples of the Preparation of the Caprolactam-Based Hydrogelators

### EXAMPLE 1

### Preparation of the Amide A1 by Reaction of 1 mol of Stearic Acid with 1 mol of Caprolactam

113.16 g of caprolactam (1 mol) and 284.48 g of stearic acid (1 mol) are introduced, under a stream of nitrogen, into a 1 litre reactor equipped with a thermometer, a condenser and a stirrer. The mixture is subsequently heated to 250° C., still under a stream of nitrogen. The reaction is monitored by the viscosity. After 15 hours, the viscosity value becomes constant (>0.32 poises or >32 mPa·s, measured on a Brookfield® CAP1000 at 120° C.) and the reaction mixture is cooled to 150° C. and then discharged into a silicone mould. Once cooled to ambient temperature, the product is micronized mechanically by grinding. A sieving is carried out in order to obtain a fine and controlled particle size distribution with an average size obtained of 7 μm.

### EXAMPLE 2

### Preparation of Amide A2 by Reaction of 1 mol of Stearic Acid with 2 mol of Caprolactam

226.32 grams of caprolactam (i.e., 2 mol) and 284.48 grams of stearic acid (i.e., 1 mol) are introduced, under a stream of nitrogen, into a 1 litre reactor equipped with a thermometer, a condenser and a stirrer.

The remainder of the procedure is identical to that described for Example 1.

III—Evaluation of the Hydrogelator Performance

1. Formulation for the Evaluation of the Hydrogelators

99 grams of demineralized water, 1 gram of ground or micronized additive as prepared according to Examples 1 and 2 (hydrogelator) to be tested and then a few drops of concentrated sodium hydroxide solution in an amount greater than 4 times, in equivalence, the carboxylic acid of the hydrogelator to be tested are introduced into a Erlenmeyer flask equipped with a magnetic bar. The Erlenmeyer flask is subsequently closed. The mixture is then stirred for more than 5 hours at 85° C. in order to have complete dissolution of the hydrogelator additive and a milky but precipitate-free mixture. Finally, the mixture is introduced into a test tube and then left standing at 25° C. for 24 hours.

Under these preparation conditions, 3 formulations were produced with the amide A1 of Example 1, the amide A2 of Example 2 and also with stearic acid as comparison reference. These 3 tests are summarized in the following Table 2.

TABLE 2
Formulations

| | | % by weight |
|---|---|---|
| | | of additive |
| | Hydrogelator or reference | vs |
| Test ref. | (comparative) additive | formulation |
| 1 | Stearic acid (comparative | 1% |
| | reference) | |
| 2 | A1 (Example 1 according to | 1% |
| | the invention) | |
| 3 | A2 (Example 2 according to | 1% |
| | the invention) | |

2. Evaluation of the Gel

The 3 formulation tests were evaluated in two ways: first according to the appearance of the formulations prepared in the test tubes after 24 hours (see Table 3) and subsequently and in particular according to their viscosities at different shear rates on a Brookfield® viscometer (see Table 4).

TABLE 3
Appearance

| Test ref. | Appearance |
|---|---|
| 1 | Suspension |
| 2 | Gel |
| 3 | Gel |

TABLE 4
Viscosities at different rates

| | Spindle | | | |
|---|---|---|---|---|
| | speed | Test 1 | Test 2 | Test 3 |
| | (rpm) | (comparative) | (invention) | (invention) |
| Thixo Index TI | | 6.03 | 7.01 | 5.23 |
| 1/10 | | | | |
| Thixo Index TI | | 5.17 | 7.06 | 6.16 |
| 5/50 | | | | |
| Viscosity | 1 | 3200* | 6100 | 3400 |
| measured | 5 | 900* | 1880 | 1510 |
| Brookfield ® at | 10 | 530* | 870 | 650 |
| 25° C. | 50 | 174* | 266 | 245 |
| (mPa · s) | 100 | 116 | 170 | 126 |

*By way of indication, it should be noted that the results shown for Comparative Test 1 are not very reproducible, given that the formulation is not homogeneous.

In contrast to stearic acid, the formulations obtained with 1% of amide A1 or A2exist in the gel form characteristic of a hydrogelator.

With regard to the viscosity results, they clearly show that the formulation comprising the amide A1 (Test 2) is thixotropic but also more viscous than the water or the formulation comprising the stearic acid.

1. Hydrogelator additive based on fatty amide, which is a product of addition reaction of a fatty acid R₁CO₂H with caprolactam and carries an end carboxyl functional group in acid form or in form salified by a neutralizing agent, wherein said additive comprises a mixture of 3 different amide compounds resulting from said reaction, and which are characterized by the number n of caprolactam units incorporated, which number is respectively 1, 2 and 3, with a mean number n of units (mean per molecule) ranging from 0.8 to 3.

2. Additive according to claim 1, said 3 compounds are defined according to the following formula (I) and respectively correspond to n=1, n=2 and n=3
R₁—C(═O)—[NH(CH₂)₅C(═O)—]ₙ-1—NH(CH₂)₅—CO₂M (I)
with M being —H or a cation in the case of said salified form, said cation being related to said neutralizing agent.

3. Additive according to claim 1 wherein said fatty acid comprises a number of carbon atoms from 10 to 24.

4. Additive according to claim 1 wherein said additive is a micronized power having a volume-average size of less than 50 μm.

5. Additive according to claim 1 in salified form and wherein said neutralizing agent is selected from the group consisting of organic and inorganic bases.

6. Additive according to claim 1 in gel form in water or as hydrogelator, having a content by weight of less than 5%.

7. Process for the preparation of an additive according to claim 1 comprising a stage of an addition reaction between a fatty acid R₁CO₂H and caprolactam with a molar ratio of said caprolactam to said fatty acid from 0.8 to 3, said process not comprising separation or purification stages.

8. An aqueous composition comprising as hydrogelator, at least one additive as defined according to claim 1.

9. A composition according to claim 8 having a pH of at least 9.

10. An aqueous binder composition of claim 8, which is an aqueous varnish, paint, ink, adhesive, cosmetic composition, or a composition for the treatment of fibres or textiles.

11. Composition according to according to claim 8 which is a surfactant.

12. (canceled)

13. (canceled)

14. (canceled)

15. (canceled)

16. (canceled)

17. The additive of claim 1, wherein mean number n of units per molecule is ranging from 0.9 to 2.5.
